(19) United States
(12) Patent Application Publication
(10) Pub. No.: US 2016/0212773 A1
(43) Pub. Date: Jul. 21, 2016

(54) POOL OF NETWORK GATEWAYS

(71) Applicant: TELEFONAKTIEBOLAGET L M ERICSSON (PUBL), Stockholm (SE)

(72) Inventors: Peter Kanderholm, Bohus (SE); Folke Ahlström, Västra Frölunda (SE); Peter Ramle, Mölnlycke (SE)

(21) Appl. No.: 14/915,364

(22) PCT Filed: Oct. 10, 2013
(86) PCT No.: PCT/EP2013/071151

§ 371 Date: Feb. 29, 2016

(51) Int. Cl. H04W 76/02; H04W 76/06; H04W 76/04

(52) U.S. Cl. CPC H04W 76/02; H04W 76/04; H04W 76/06; H04W 88/16

(57) ABSTRACT

A gateway node is configured to act as a gateway of a core network to one or more external Packet Data Networks, PDNs, and configured to provide connectivity for radio terminals served by the first gateway node to one or more of the PDNs, and configured to exchange information with one or more other network gateway nodes to provide a network gateway pool. The method comprises: obtaining pool information comprising information indicative of the external PDNs being served by each gateway node in the gateway pool to enable distribution of Packet Data Network, PDN, connections among the gateway nodes in the gateway pool, blocking at least one external PDN served by the first gateway node for creation of new PDN connections to the external PDN, and forwarding any creation of a new PDN connection for the blocked external PDN to a second gateway node in the gateway pool.

### TECHNICAL FIELD

Exemplifying embodiments presented herein are directed towards a network gateway node configured to operatively act as a gateway between a communication network and other communication networks, and configured to operatively exchange information with a number of other network gateways of the same or similar kind for providing a pool of network gateways, and a corresponding method in the network gateway for providing a pool of network gateways.

### BACKGROUND

In a wireless communications network radio terminals communicate with one or more Core Networks (CNs) via one or more Radio Access Network(s) (RAN).

The radio terminals may e.g. be a mobile station (MS) or a user equipment (UE) or similar wireless device, e.g. such as mobile phones, or cellular phones, or laptops or similar devices with wireless capability, and thus can be, for example, portable, pocket, hand-held, computer-comprised, or vehicle-mounted wireless or other wireless devices which communicate voice and/or data with a radio access network.

The Radio Access Network (RAN) covers a geographical area which is divided into cell areas, with each cell area being served by a base station, e.g. a Radio Base Station (RBS). In some radio access networks the base station is e.g. called “NodeB” or “B node” or enhanced NodeB (eNB). A cell is a geographical area where radio coverage is provided by the equipment of a radio base station at a base station site. Each cell is identified by an identity within the local radio area, which may be broadcasted in the cell. The base stations communicate via an air interface with radio terminals within range of the base stations.

In some versions of the RAN, several base stations are typically connected, e.g. by landlines or microwave links, to a Radio Network Controller (RNC) or a Base Station Controller (BSC) or similar. The radio network controller or similar supervises and coordinates various activities of the plural base stations connected thereto. The radio network controllers are typically connected to one or more core networks.

For example, the General Packet Radio Service (GPRS) is a wireless communication system, which evolved from the GSM. The GSM EDGE Radio Access Network (GERAN) is a radio access network for enabling radio terminals to communicate with one or more core networks.

For example, the Universal Mobile Telecommunications System (UMTS) is a third generation wireless communication system, which evolved from the Global System for Mobile Communications (GSM), and is intended to provide improved mobile communication services based on Wideband Code Division Multiple Access (WCDMA) access technology.

Typically the Core Network (CN), to which the radio terminal communicates via the RAN, comprises a number of core network nodes.

One such core network node is the network gateway node. The network gateway node provides connectivity for the radio terminals of the communication network to one or more external Packet Data Networks (PDNs). A radio terminal may have simultaneous connectivity with more than one network gateway node for accessing multiple PDNs. The network gateway node may e.g. be a Gateway GPRS Support Node (GGSN) or a PDN Gateway (PGW).

Typically the network gateway provides PDN connectivity by creating a PDN-connection for a radio terminal to a PDN served by the network gateway. The PDN connection may be requested by the radio terminal, e.g. by sending a message to the network gateway, e.g. a PDN Connectivity Request message or similar.

An Access Point Name (APN) is used to identify the PDN to which the PDN-connection is to be created for the radio terminal. Thus, a PDN-connection is a connection for a radio terminal to a PDN identified by an APN. The APN may e.g. be provided to the network gateway by the radio terminal, e.g. in a message, sent when requesting the PDN connection, e.g. a PDN Connectivity Request message or similar. Alternatively the APN may e.g. be known by the network gateway (e.g. predefined in the network gateway) such that the network gateway knows that this APN is to be used for the particular radio terminal.

Thus, the APN identifies the PDN that a radio terminal wants to communicate with. In addition to identifying a PDN, an APN may also be used to define the type of service—e.g. connection to wireless application protocol (WAP) server, multimedia messaging service (MMS)—that is provided by the PDN. APN is e.g. used in 3GPP data access networks, e.g. the above mentioned GPRS and/or in the Evolved Packet Core (EPC).

The APN structure may e.g. comprise a network identifier and an operator identifier. The network identifier may e.g. define the external network to which the network gateway is connected. Optionally, it may also include the service requested by the radio terminal. The operator Identifier may define the specific operator's packet domain network in which the network gateway is located. This part of the APN may be optional. The operator Identifier may e.g. comprise the Mobile Country Code (MCC) and the Mobile Network Code (MNC) which together may uniquely identify a mobile network operator.

The use of PDNs, PDN connections and APNs is well known to those skilled in the art, especially within the framework of the 3GPP specifications, and it needs no further detailed explanations.

Now, there are occasions where an existing PDN-connection to a PDN identified by an APN should be moved from a network gateway currently hosting the PDN-connection for a radio terminal to another network gateway that is also serving the PDN identified by the APN. For example, the PDN-connections may have to be moved from a first network gateway to another network gateway to allow service and maintenance of the first network gateway, or to accomplish an improved load sharing between the network gateways, or to allow for special treatment of PDN connections, e.g. like debug of LI.

Existing solutions for moving PDN-connections from a network gateway such as a GGSN or a PGW to another GGSN or PGW is based on the assumption that User Equipments (UEs) or similar radio terminals will eventually disconnect from the network by themselves.

Thus, an existing method for emptying a GGSN/PGW from PDN-connections relies on PDN-connection starvation. The PDN-connection starvation is typically done by reconfiguring the Domain Name Server (DNS) to block creation of new PDN-connections at the GGSN/PGW node. This is typically done by removing the DNS routing entries of the GGSN/PGW with the effect that no new PDN-connections will be routed to the GGSN/PGW node in question. The existing PDN-connections hosted by the GGSN/PGW node will slowly disappear from the node as they spontaneously disconnect. When a UE then reconnects to the GGSN/PGW node the GGSN/PGW is blocked in the Domain Name Server (DNS) and another GGSN/PGW serving the requested PDN will be selected to host a PDN-connection for the UE. A repopulation of a GGSN/PGW node will typically require that new PDN-connections are directed to the node while other GGSN/PGW nodes are blocked for new PDN-connections by reconfiguring the DNS.

However, waiting for PDN-connections to spontaneously disconnect and reconnect to the network can take a long time, several days or weeks depending on the number and types of UEs in the network. This spontaneous disconnect time will most likely increase in tie future as more and more UEs are very seldom restarted (Always connected) and may also be substantially stationary (e.g. in M2M applications).

The above inefficient way of moving PDN-connections from a first network gateway (e.g. a GGSN or a PGW) to another network gateway is not desired.

For example, within the Packet Core Network market there is a demand for fast feature deliveries and fast response to software corrections and updates, which requires a software upgrade method that is fast and with minimal UE impact. For example, load-sharing or load-steering among network gateways require an efficient way of moving PDN-connections.

### SUMMARY

In view of the above there seems to be a need for an improved method for distributing PDN-connections between network gateway nodes in a pool of network gateway nodes. In particular, there is a need for an improved pool of network gateways.

Some of the drawback indicated above are mitigated or eliminated by an embodiment of the present solution directed to a method in a first network gateway node configured to act as a gateway of a core network to one or more external Packet Data Networks, PDNs, and configured to provide connectivity for radio terminals to one or more of the PDNs, and configured to exchange information with one or more other network gateway nodes to provide a network gateway pool. The method comprises: obtaining pool information comprising information indicative of the external PDNs being served by each gateway node in the gateway pool to enable distribution of Packet Data Network, PDN, connections among the gateway nodes in the gateway pool; blocking at least one external PDN served by the first gateway node for creation of new PDN connections to the external PDN; forwarding any creation of a new PDN connection for the blocked external PDN to a second gateway node in the gateway pool.

Some of the drawback indicated above are also mitigated or eliminated by an embodiment of the present solution directed to a first network gateway node configured to act as a gateway of a core network to one or more external Packet Data Networks, PDNs, and configured to provide connectivity for radio terminals to one or more of the PDNs, and configured to exchange information with one or more other network gateway nodes to provide a network gateway pool. The first network gateway node comprises a processor arrangement and a memory arrangement, such that said memory arrangement comprises instructions executable by said processor arrangement, whereby the first network node is configured to: obtain pool information comprising information indicative of the external PDNs being served by each gateway node in the gateway pool to enable distribution of Packet Data Network, PDN, connections among the gateway nodes in the gateway pool; block at least one external PDN served by the first gateway node for creation of new PDN connections to the external PDN; forward any creation of a new PDN connection for the blocked external PDN to a second gateway node in the gateway pool.

It is noted that the solution described herein, with reference to exemplifying embodiments, relates to all possible combinations of features recited in the claims. Further features of, and advantages with, the present solution will become apparent when studying the appended claims and the following description. Those skilled in the art realize that different features of the present solution can be combined to create embodiments other than those described in the following.

### BRIEF DESCRIPTION OF THE DRAWINGS

The foregoing will be apparent from the following more particular description of the exemplifying embodiments, as illustrated in the accompanying drawings in which like reference characters refer to the same parts throughout the different views.

FIG. 1 is a schematic illustration of a well known exemplifying LTE architecture for 3GPP accesses within an Evolved Packet System (EPS),

FIG. 2 is a schematic illustration of a well known exemplifying GPRS architecture based on S4 interface;

FIG. 3 is another schematic illustration of an exemplifying LTE architecture,

FIG. 4 is another schematic illustration of an exemplifying GPRS architecture;

FIG. 5a is a schematic illustration of a network gateway pool 500 according to an exemplifying embodiment of the present solution,

FIG. 5b is a more detailed schematic illustration of the network gateway pool 500 shown in FIG. 5a,

FIG. 5c is a schematic illustration of the network gateway pool 500 in FIG. 5b, where the entire gateway GW2 is blocked for creation of any new PDN-connections for radio terminals,

FIG. 5d is a schematic illustration of the network gateway pool 500 in FIG. 5b, where access point name APN2 served by gateway GW3 is blocked for creation of new PDN-connections to PDN2 identified by APN2,

FIG. 5e is a schematic illustration of the network gateway pool 500 in FIG. 5c where existing PDN-connections P2, P3 that are still associated with APN2, blocked by gateway GW2, is now moved to GW3 currently serving APN2,

FIG. 6 is a schematic illustration of an exemplifying flowchart showing operations of some exemplifying embodiments described herein,

FIG. 7 is a schematic illustration of a signaling diagram depicting the operations of the flow diagram in FIG. 6, now indicating the nodes and messages etc that is involved in the operations,

FIG. 8 is a schematic illustration of a network gateway node according to some embodiments described herein.

### DETAILED DESCRIPTION

In the following description, for purposes of explanation and not limitation, specific details are set forth, such as particular components, elements, techniques, etc. in order to provide a thorough understanding of the exemplifying embodiments. However, it will be apparent to one skilled in the art that the exemplifying embodiments may be practiced in other manners that depart from these specific details. In other instances, detailed descriptions of well-known methods and elements are omitted so as not to obscure the description of the example embodiments. The terminology used herein is for the purpose of describing the example embodiments and is not intended to limit the embodiments presented herein.

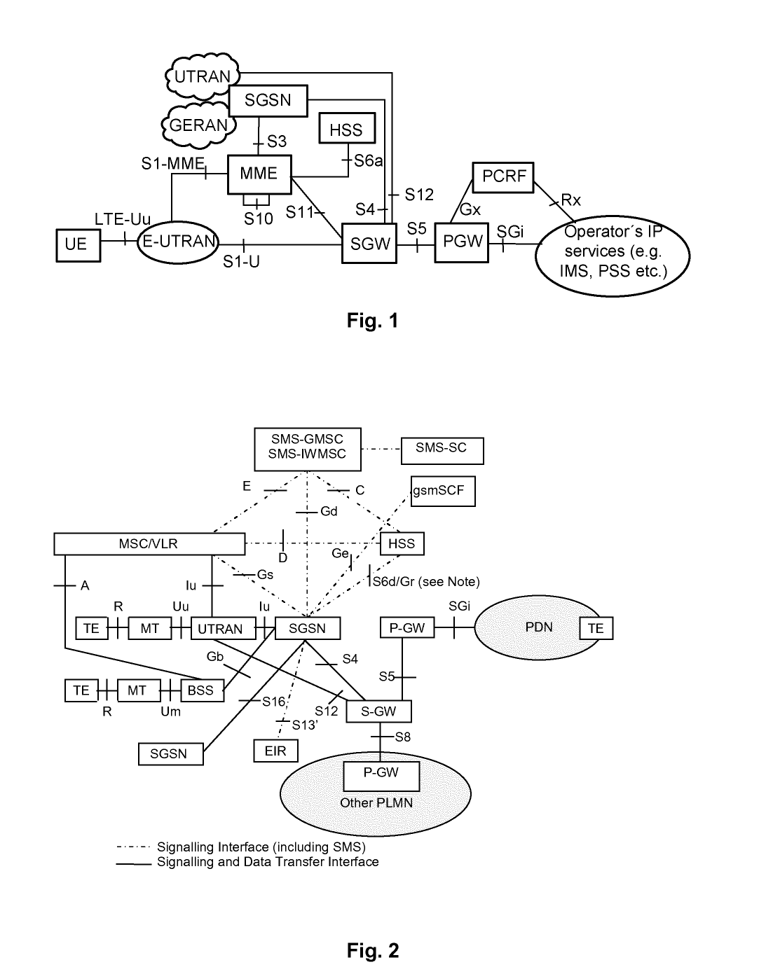

FIG. 1 shows a schematic overview of a well known exemplifying wireless communication system. The system is a so called LTE based system. It should be pointed out that the terms “LTE” and “LTE based” system is here used to comprise both present and future LTE based systems, such as, for example, advanced LTE systems.

It should be appreciated that although FIG. 1 shows a wireless communication system in the form of a LTE based system, the example embodiments herein may also be utilized in connection with other wireless communication systems comprising nodes and functions that correspond to the nodes and functions of the system in FIG. 1.

FIG. 2 shows a schematic overview of another exemplifying wireless communication system. The system is a well known exemplifying GPRS architecture.

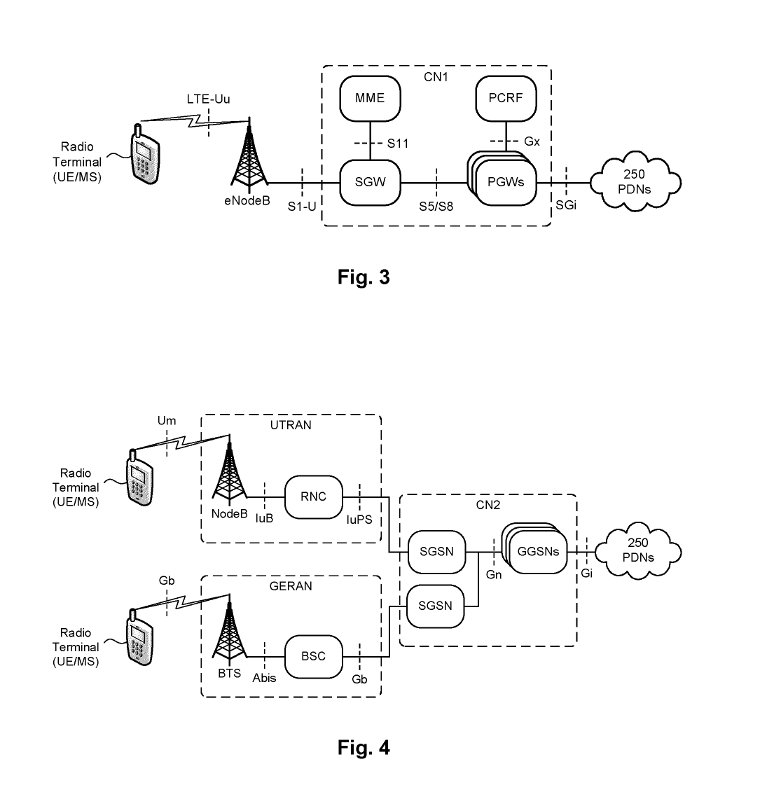

FIG. 3 shows another schematic illustration of a exemplifying LTE architecture. As can be seen, the system comprises a base station in the form of an eNodeB, connected to a Serving Gateway (SGW), in turn connected to a Mobility Management Entity (MME) and a pool of PDN Gateways (PGWs), which in turn is connected to a Policy and Charging Rules Function (PCRF). The MME, the SGW, the PGWs and the PCRF are exemplifying core network nodes in an exemplifying first core network CN1.

The eNodeB is a radio access node that interfaces with a radio terminal, which is denoted User Equipment (UE) in LTE. In fact, the eNodeBs of the system forms the radio access network E-UTRAN for LTE. It should be understood that several UEs are normally served by the eNodeB. However, for the sake of simplicity only one UE is illustrated and discussed with reference to FIG. 3.

The SGW routes and forwards user data packets, while also acting as the mobility anchor for the user plane during inter-eNB handovers and as the anchor for mobility between LTE and other 3GPP technologies (terminating S4 interface and relaying the traffic between 2G/3G systems and PDN GW). For idle state UEs, the SGW terminates the DL data path and triggers paging when DL data arrives for the UE. It manages and stores UE contexts, e.g. parameters of the IP bearer service, network internal routing information. It also performs replication of the user traffic in case of lawful interception.

The MME is the key control-node for the LTE access-network. It is responsible for idle mode UE tracking and paging procedure including retransmissions. It is involved in the bearer activation/deactivation process and is also responsible for choosing the SGW for a UE at the initial attach and at time of intra-LTE handover involving Core Network (CN) node relocation. It is responsible for authenticating the user (by interacting with the HSS). The Non-Access Stratum (NAS) signaling terminates at the MME and it is also responsible for generation and allocation of temporary identities to UEs. It checks the authorization of the UE to camp on the service provider's Public Land Mobile Network (PLMN) and enforces UE roaming restrictions. The MME is the termination point in the network for ciphering/integrity protection for NAS signaling and handles the security key management. Lawful interception of signaling is also supported by the MME. The MME also provides the control plane function for mobility between LTE and 2G/3G access networks with the S3 interface terminating at the MME from the SGSN. The MME also terminates the S6a interface towards the home HSS for roaming UEs

The PGW is a network gateway node that provides connectivity for the UE to one or more external Packet Data Networks (PDNs) 250 by being the point of exit and entry of traffic for the UE. A UE may have simultaneous connectivity with more than one PGW for accessing multiple PDNs. The PGW performs policy enforcement, packet filtering for each user, charging support, lawful Interception and packet screening. Another key role of the PGW is to act as the anchor for mobility between 3GPP and non-3GPP technologies such as WiMAX and 3GPP2 (CDMA 1X and EvDO).

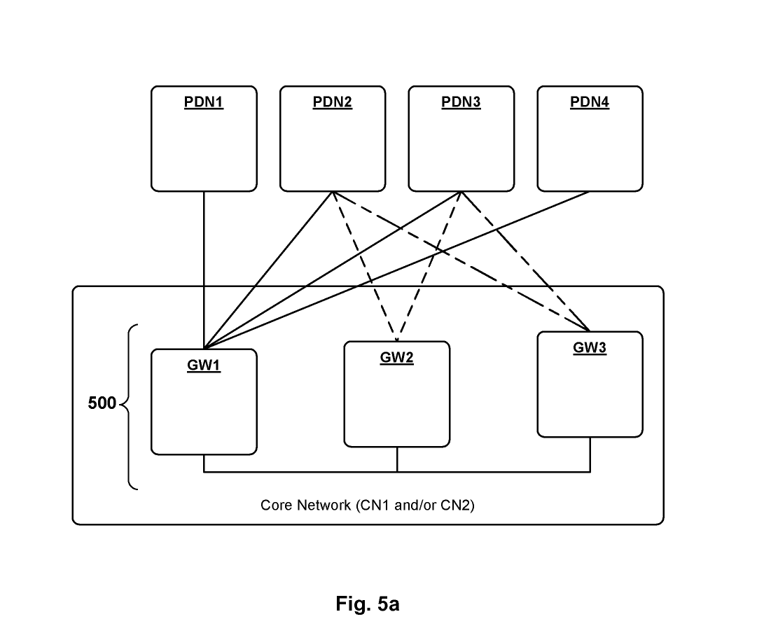

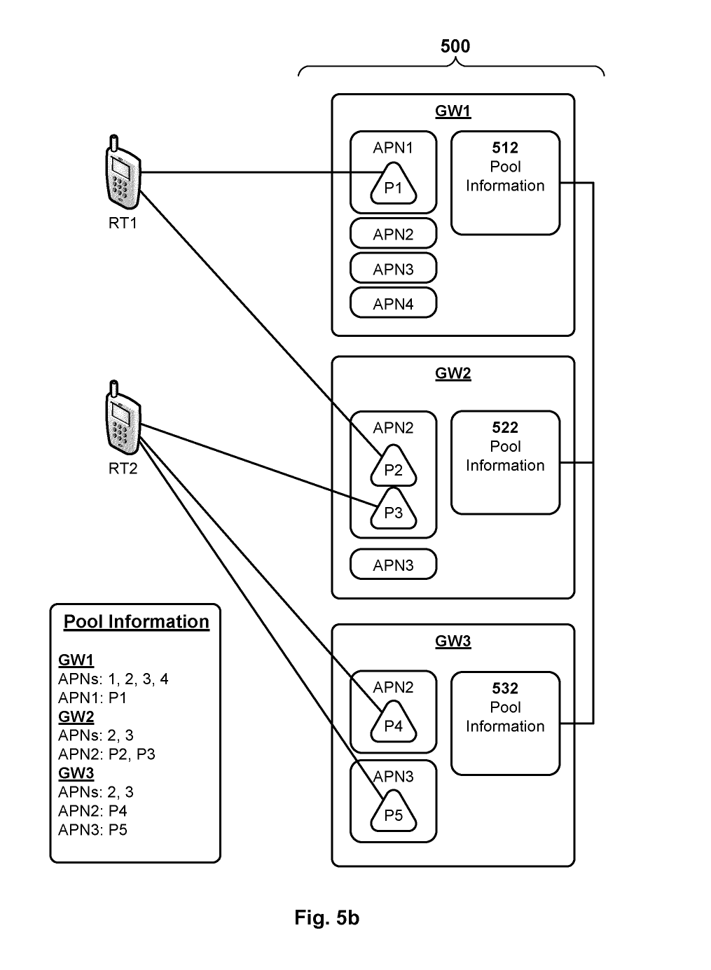

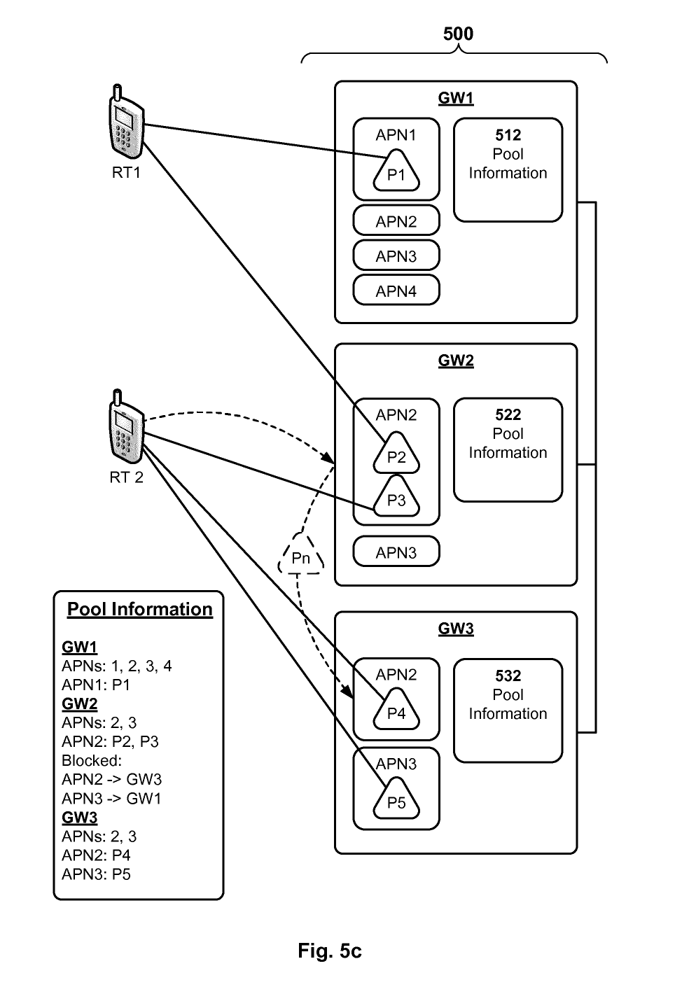

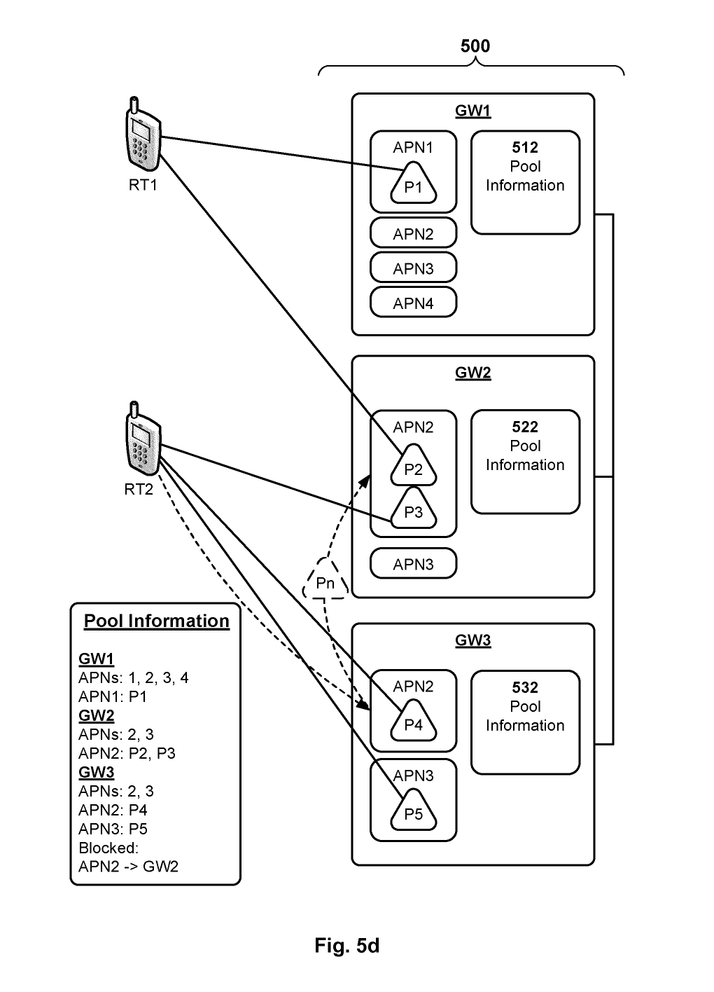

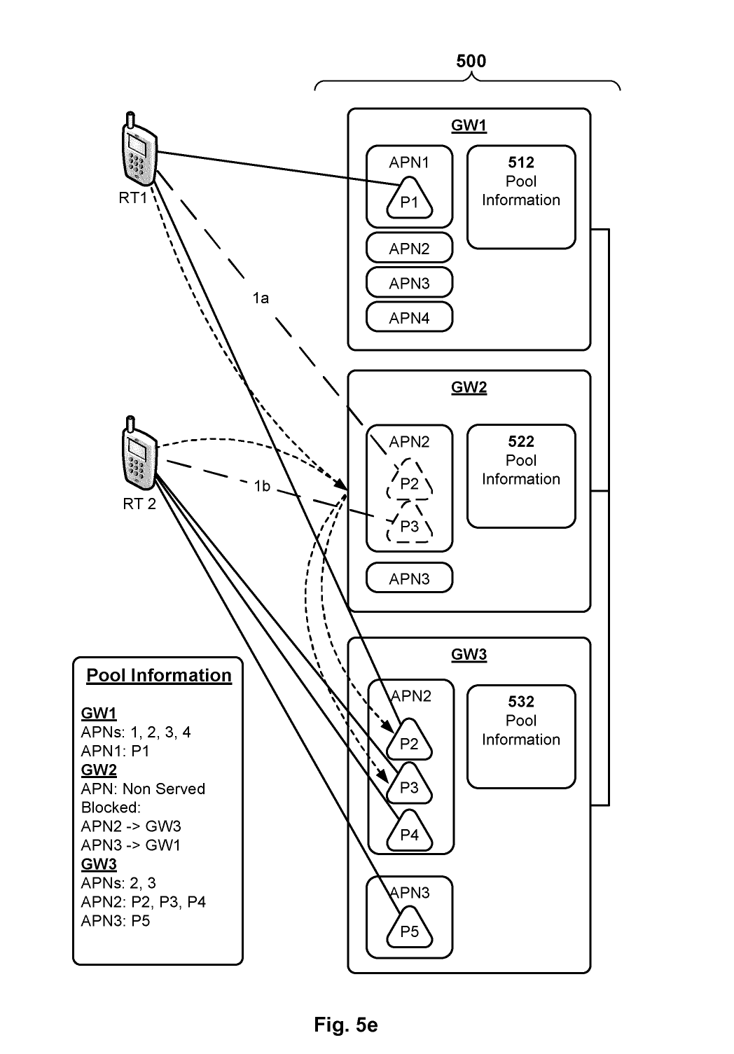

The PGWs in FIG. 3 form an exemplifying pool of several PGWs configured to exchange information between each other, wherein each PGW is configured to operatively provide connectivity for one or more UEs or similar to at least one external PDN. A pool of network gateways such as a pool of PGWs will be discussed in more detail below with reference to FIGS. 5a-5d.

The PCRF determines policy rules in real-time with respect to the radio terminals of the system. This may e.g. include aggregating information in real-time to and from the core network and operational support systems etc of the system so as to support the creation of rules and/or automatically making policy decisions for user radio terminals currently active in the system based on such rules or similar. The PCRF provides the PGW with such rules and/or policies or similar to be used by the PGW acting as a Policy and Charging Enforcement Function (PCEF).

FIG. 4 shows another schematic illustration of an exemplifying GPRS architecture. As can be seen, the system comprises a pool of Gateway GPRS Support Nodes (GGSNs) connected to a first Serving GPRS Support Node (SGSN) and a second SGSN. In turn, the first SGSN is connected to a Radio Network Controller (RNC) that is connected to a base station in the form of a NodeB, whereas the second SGSN is connected to a Base Station Controller (BSC) that is connected to a base station in the form of a Base Transceiver Station (BTS). The SGSNs and the GGSNs are exemplifying core network nodes in an exemplifying second core network CN2.

The GGSN is a network gateway node that provides connectivity for radio terminals such as UEs or MSs to one or more external Packet Data Networks (PDNs) 250 by being the point of exit and entry of traffic for the radio terminal. The GGSN is a main component of the GPRS network. The GGSN is responsible for the interworking between the GPRS network and one or more external Packet Data Networks (PDNs) 250, e.g. like the Internet and X.25 networks. The GGSN is the anchor point that enables the mobility of the user terminal in the GPRS/UMTS networks and it may be seen as the GPRS equivalent to the Home Agent in Mobile IP. It maintains routing necessary to tunnel the Protocol Data Units (PDUs) to the SGSN that services a particular Mobile Station (MS). The GGSN converts the GPRS packets coming from the SGSN into the appropriate packet data protocol (PDP) format (e.g., IP or X.25) and sends them out on the corresponding packet data network. In the other direction, PDP addresses of incoming data packets are converted to the GSM address of the destination user. The readdressed packets are sent to the responsible SGSN. The GGSN is responsible for IP address assignment and is the default router for the connected user equipment (UE). The GGSN also performs authentication and charging functions. Other functions include subscriber screening, IP Pool management and address mapping, QoS and PDP context enforcement.

The GGSNs in FIG. 4 form a exemplifying pool of several GGSNs configured to exchange information between each other, wherein each GGSN is configured to operatively provide connectivity for one or more UEs or similar to at least one external PDN. A pool of network gateways such as a pool of GGSNs will be discussed in more detail below with reference to FIGS. 5a-5d.

The SGSN is responsible for the delivery of data packets from and to the radio terminals such as mobile stations within its geographical service area. Its tasks include packet routing and transfer, mobility management (attach/detach and location management), logical link management, and authentication and charging functions. The location register of the SGSN stores location information (e.g., current cell, current Visitor Location Register (VLR)) and user profiles (e.g., International Mobile Station Identity (IMSI), address(es) used in the packet data network) of all GPRS users registered with this SGSN.

The RNC is a node in the UMTS radio access network (UTRAN) and is responsible for controlling the NodeBs that are connected to it. The RNC carries out radio resource management, some of the mobility management functions and is the point where encryption is done before user data is sent to and from the mobile. The RNC connects to a Circuit Switched Core Network through Media Gateway (MGW) and to the SGSN in the Packet Switched Core Network. It should be understood that several UEs and/or MSs are normally served by the NodeB. However, for the sake of simplicity only one UE/MS is illustrated and discussed with reference to FIG. 4.

The BSC is a node in the GSM Radio Access Network (GERAN) and is responsible for controlling the BTSs that are connected to it. The BSC carries out radio resource management and some of the mobility management functions. It should be understood that several UEs and/or MSs are normally served by the BTS. However, for the sake of simplicity only one UE/MS is illustrated and discussed with reference to FIG. 4.

As can be seen in FIGS. 3 and 4, there are radio terminals such as UEs and/or MSs that communicate with the eNodeB and/or the RNC via a NodeB and/or the BSC via a BTS using an air interface such as LTE-Uu, Um and Gb interface respectively. This makes it possible for the radio terminals to access resources provided by the core network of the systems respectively. A skilled person having the benefit of this disclosure realizes that vast number of well known radio terminals can be used in the various embodiments of the present solution. The radio terminal may e.g. be a cell phone device or similar, e.g. such as a Mobile Station (MS) or a User Equipment (UE) or similar, e.g. defined by the standards provided by the 3GPP. Thus, the radio terminal needs no detailed description as such. However, it should be emphasized that the mobile radio terminals may be embedded (e.g. as a card or a circuit arrangement or similar) in and/or attached to various other devices, e.g. such as various laptop computers or tablets or similar or other mobile consumer electronics or similar, or vehicles or boats or air planes or other movable devices, e.g. intended for transport purposes. Indeed, the radio terminal may even be embedded in and/or attached to various semi-stationary devices, e.g. domestic appliances or similar, or consumer electronics such as printers or similar having a semi-stationary mobility character.

FIG. 5a is a schematic illustration of a network gateway pool 500 according to an exemplifying embodiment of the present solution. The exemplifying network gateway pool 500 comprises three exemplifying network gateway nodes GW1, GW2 and GW3, each configured to operatively act as a gateway of one or more core networks CN1 and/or CN2 to one or more external Packet Data Networks, PDN1, PDN2, PDN3 and/or PDN4. The gateway nodes GW1, GW2, GW3 are configured to operatively provide connectivity for radio terminals served by the core network to one or more of the PDNs, PDN1, PDN2, PDN3 and/or PDN4. The gateway nodes GW1, GW2, GW3, GW4 are configured to communicate with one or more other network gateways (GW1, GW2) of the same or similar kind to provide a network gateway pool (500). The gateway nodes GW1, GW2 and GW3 may e.g. be a GGSNs or a PGWs or similar and the core network may be of the same or similar kind as core network CN1 or CN2 discussed above with reference to FIGS. 3 and 4. It is preferred that PDN1, PDN2, PDN3, PDN4 are external Packet Data Networks (PDNs), e.g. such as the PDN 250 or similar discussed above with reference to FIGS. 3 and 4.

As will be further discussed below with reference to FIGS. 5b-5d, it is assumed that PDN1 is identified by access point name APN1, and that PDN2 is identified by access point name APN2, and that PDN3 is identified by access point name APN3, and that PDN4 is identified by access point name APN4.

FIG. 5b is a schematic illustration of the exemplifying network gateway pool 500 shown in FIG. 5a. The exemplifying gateway pool 500 comprises three (3) network gateways, GW1, GW2 and GW3. Each gateway node is configured to operatively serve one or more APNs so as to create a PDN-connection for a radio terminal served by the network gateway to a PDN identified by an APN.

As can be seen in FIG. 5b, GW1 serves access point names APN1-APN4, whereas GW2 serves access point names APN2 and APN3, whereas GW3 serves access point names APN2 and APN3.

A first radio terminal RT1 has established a first PDN-connection P1 to the first PDN1 identified by the first APN1, and a second PDN-connection P2 to the second PDN2 identified by the second APN2. The first PDN-connection P1 is hosted by the first gateway GW1 and the second PDN-connection P2 is hosted by the second gateway GW2.

A second radio terminal RT2 has established a third PDN-connection P3 to the second PDN2 identified by the second APN2, and a fourth PDN-connection P4 to the second PDN2 identified by the second APN2, and a fifth PDN-connection P5 to the third PDN3 identified by the third APN3. The third PDN-connection P3 is hosted by the second gateway GW2, whereas the fourth PDN-connection P4 and the fifth PDN-connection P5 are hosted by the third gateway GW2.

As can be see in FIG. 5b, each network gateway node GW1, GW2 and GW3 comprises Pool Information 512, 522 and 532 respectively. The Pool Information comprises information indicative of the external PDNs served by each gateway node GW1, GW2, GW3 in the gateway pool (500) so as to enable distribution and/or redistribution of PDN-connections among the gateways in the gateway pool 500. The PDN-connections to be redistributed may be hosted by the gateway nodes in the pool 500 and/or they may be in the process of being created as will be discussed further below with reference to FIGS. 5c-5d. In addition it is preferred that the Pool Information comprise information indicating whether all or a number of APNs served by a particular gateway node are blocked by that gateway with respect to creation of new PDN-connections. A gateway or an APN may be blocked for any reason, e.g. due to maintenance or similar or for obtaining an improved load distribution or similar in the gateway pool.

The Pool Information may also comprise information indicating another gateway node in the pool 500 to which a creation of a new PDN-connection is to be forwarded when a first gateway node blocks the creation of such PDN-connections.

The pool-information may also comprise information indicating the identity and/or address of all nodes in the pool.

It is preferred that the Pool Information is the same for all network gateway nodes GW1, GW2, GW3 in the pool 500, possibly with exception for brief periods during which the pool information is updated in the network gateway nodes GW1, GW2, GW3. Thus, the Pool Information is preferably a Common Pool Information.

It is preferred that the Pool Information in all gateways of the pool 500 is updated when status relating to the Pool Information changes in a particular gateway node. The status in a particular gateway may e.g. change in that one or more APNs served by the gateway are blocked or becomes unblocked, as will be further discussed below with reference to FIGS. 5c-5d and FIGS. 6-7. The status in a particular gateway may e.g. change in that there is a change in the gateway node to which a creation of a new PDN-connection is to be forwarded when the particular gateway node blocks the creation of such PDN-connections.

The exemplifying Common Pool Information shown in FIG. 5b comprises information indicating:
that GW1 serves APN1, APN2; APN3 and APN4, and
optionally that GW1 hosts the first PDN-connection P1 for the first radio terminal RT1.
that GW2 serves APN2 and APN3, and
optionally that GW2 hosts the second PDN-connection P2 for the first radio terminal RT1 and the third PDN-connection P3 for the second radio terminal RT2.
that GW3 serves APN2 and APN3, and
optionally that GW3 hosts the fourth PDN-connection P4 and the fifth PDN-connection P5 for the second radio terminal RT2.

FIG. 5c is a schematic illustration of the network gateway pool 500 in FIG. 5b where the second network gateway GW2 has been blocked for creation of any new PDN-connections for radio terminals. In this example, all APNs served by gateway GW2 are blocked for creation of new PDN-connections. However, it should be emphasized that only one or a few APNs served by a gateway node GW1, GW2, GW3 may be blocked.

Blocking all APNs or a number of APNs served by a gateway node for creation of new PDN-connections may be done in any suitable manner. Blocking may e.g. be ordered centrally by the operator of the wireless communication network comprising the gateway node, e.g. using a network control function such as an Operation and Maintenance (OAM) function or similar of the network. Alternatively, a blocking may e.g. be done locally, e.g. by a service technician interacting locally with the gateway node for which a number of APNs are to be blocked, e.g. using suitable service equipment locally connected to the gateway node. Indeed, blocking all or a number of APNs served by a gateway node for creation of new PDN-connections may even be done by the gateway node itself, e.g. when the gateway node detects an overload of hosted PDN-connections that should preferably be distributed among the other gateway nodes in the gateway pool. As mentioned in the Background section; an existing method for blocking an APN served by a GGSN/PGW is typically employing a reconfiguring of the Domain Name Server (DNS) to block creation of new PDN-connections identified by the APN at the GGSN/PGW node. This is typically done by removing the DNS routing entries of the GGSN/PGW with the effect that no new PDN-connections will be routed to the GGSN/PGW node in question.

As already mentioned, the second network gateway GW2 in FIG. 5c has been blocked for creation of any new PDN-connection (both APN2 and APN3 have been blocked). Thus, when the second radio terminal RT2 tries to create a new PDN-connection to PDN2 via GW2 using APN2 it follows that the creation will be blocked. Moreover, as illustrated in FIG. 5c, the creation will be forwarded to the third gateway GW3 that is currently serving APN2, and GW3 will thus create a new PDN-connection (not shown) to PDN2 via GW3 using APN2. The forwarding by the second gateway node GW2 to the third gateway node GW3 is preferably based on the Pool Information indicating that GW3 is currently serving APN2.

Thus, the exemplifying Common Pool Information shown in FIG. 5c comprises information indicating:
that GW1 serves APN1, APN2; APN3 and APN4, and optionally that GW1 hosts the first PDN-connection P1 for the first radio terminal RT1.
that GW2 serves APN2 and APN3, and
optionally that GW2 still hosts the old second PDN-connection P2 for the first radio terminal RT1 and the old third PDN-connection P3 for the second radio terminal RT2.
that GW2 has blocked APN2 and APN3 for creation of new PDN-connections,
preferably that creation of new PDN-connections for PDNs served by GW2 should be forwarded to a gateway that serves the PDN in question, i.e. in this case creation of PDN-connections to PDN2 using APN2 should be forwarded to GW3, whereas creation of PDN-connections to PDN3 using APN3 should be forwarded to GW1.
that GW3 serves APN2 and APN3, and
optionally that GW3 hosts the fourth PDN-connection P4 and the fifth PDN-connection P5 for the second radio terminal RT2.

FIG. 5d is a schematic illustration of the network gateway pool 500 in FIG. 5b. Here, only access point name APN2 served by gateway GW3 is blocked by GW3 for creation of new PDN-connections to PDN2 that is identified by APN2. Creation of new PDN-connections to PDN3 identified by APN3 are not blocked by GW3 in this example.

Thus, the exemplifying Common Pool Information shown in FIG. 5d comprises information indicating:
that GW1 serves APN1, APN2; APN3 and APN4, and
optionally that GW1 hosts the first PDN-connection P1 for the first radio terminal RT1.
that GW2 serves APN2 and APN3, and
optionally that GW2 hosts the second PDN-connection P2 for the first radio terminal RT1 and the third PDN-connection P3 for the second radio terminal RT2.
that GW3 serves APN2 and APN3, and
optionally that GW3 still hosts the fourth PDN-connection P4 and the fifth PDN-connection P5 for the second radio terminal RT2.
that GW3 has blocked APN2 for creation of new PDN-connections.
preferably that creation of new PDN-connections for PDNs served by GW3 should be forwarded to a gateway that serves the PDN in question, i.e. in this case creation of PDN-connections to PDN2 using APN2 should be forwarded to GW2.

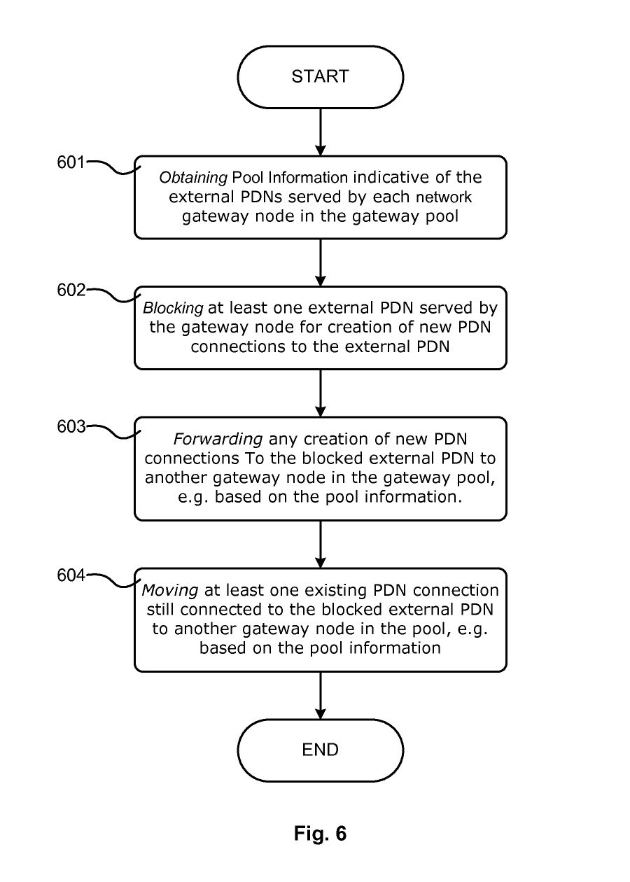

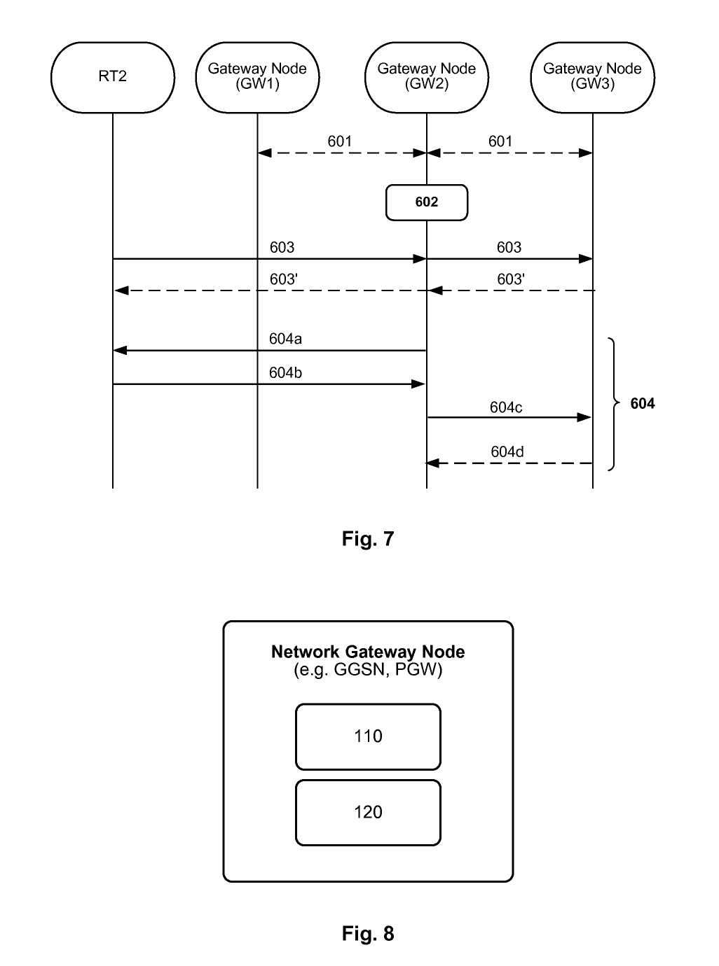

FIG. 5e is a schematic illustration of the network gateway pool 500 in FIG. 5b. Here, all access point names served by gateway GW2 are blocked for creation of new PDN-connections. This is the same situation as previously described with reference to FIG. 5b. However, in FIG. 5e it is schematically illustrated that the second PDN-connection P2 for the first radio terminal RT1 previously hosted by the second gateway node GW2 (see item 1a and dashed P2 triangle in FIG. 5e) has been moved such that the second PDN-connection P2 or a corresponding connection is now hosted by the third gateway GW3. Similarly, in FIG. 5e it is schematically illustrated that the third PDN-connection P3 for the second radio terminal RT2 previously hosted by the second gateway node GW2 (see item 1b and dashed P3 triangle in FIG. 5e) has been moved such that the third PDN-connection P3 or a corresponding connection is now hosted by the third gateway GW3. Exemplifying embodiments for moving the PDN-connections will be further discussed below with reference to FIGS. 6-7.

Thus, the exemplifying Common Pool Information shown in FIG. 5e comprises information indicating:
that GW1 serves APN1, APN2; APN3 and APN4.
optionally that GW1 hosts the first PDN-connection P1 for the first radio terminal RT1.
that GW2 serves no APNs.
optionally that GW2 hosts no second PDN-connections.
that GW3 serves APN2 and APN3.
optionally that GW3 hosts PDN-connections P2 for the first radio terminal RT1, and PDN-connections P3, P4, P5 for the second radio terminal RT2.

FIG. 6 illustrates a flow diagram depicting exemplifying operations which may be taken by a network gateway node, e.g. a GGSN or PGW or similar, in a pool of network gateways (i.a. a network gateway pool).

FIG. 7 illustrates a signaling diagram depicting the operations of the flow diagram in FIG. 6, now indicating the nodes and messages etc that is involved in the operations. The exemplifying operations 601, 602, 603 illustrated in FIGS. 6-7 are performed in a network gateway (e.g. node GW2) of the network gateway pool 500. The network gateway node GW2 is configured to act as a gateway of a core network to one or more external Packet Data Networks (PDNs). The core network may be of the same or similar kind as CN1 or CN2 discussed above with reference to FIGS. 3-4. Similarly, the PDNs may be of the same or similar kind as PDN 250 discussed above with reference to FIG. 3-4, or of the same or similar kind as one or more of PDN1-PDN4 discussed above with reference to FIG. 5a. The network gateway node GW2 is preferably configured to operatively provide connectivity for one or more radio terminals to one or more of the PDNs. The radio terminals may be of the same or similar kind as RT1, RT2 discussed above with reference to FIGS. 5b-5e. Moreover, the gateway node GW2 is configured to operatively communicate with one or more of the other gateway nodes of the same or similar kind (e.g. such as GW1 and/or GW3) to provide the network gateway pool 500 as schematically indicated in FIG. 5a.

The exemplifying operations 601, 602, 603 illustrated in FIGS. 6-7 will now be discussed in some detail below.

Example Operation 601:

A first exemplifying operation performed in the network gateway node GW2 is obtaining of pool information, at least comprising information indicative of the external PDNs being served by each gateway node GW1, GW2, GW3 in the gateway pool 500. As will be discussed below in connection with operations 602 and 603, the obtained pool information enables distribution of PDN-connections among the gateway nodes in the gateway pool 500.

It is preferred that the Pool Information is Common Pool Information as discussed above with reference to FIG. 5b-5e. Indeed, Pool Information and/or Common Pool Information that comprises information about the external PDNs being served by each gateway node in the gateway pool also inherently comprises information indicating the identity of each gateway node in the pool.

It is preferred that the network gateway pool 500 is set up by the gateway nodes in the gateway pool 500 exchanging messages comprising pool information such that each node in the pool has access to the same Common Pool Information. The identity of the other gateway nodes in the pool and other pool information may e.g. be obtained by each gateway node receiving and/or sending such information from and/or to the other gateway nodes. Each gateway node may e.g. push and/or pull pool information with respect to the other gateway nodes in the pool. Each gateway node may e.g. be are of the other gateway nodes in the pool by being provided at set up with information indicating the identity of the other gateway nodes in the pool, or by using any suitable well known self-organizing procedure to retrieve information about all the gateway nodes of the pool to collect and distribute the pool information among the gateway nodes of the pool so as to as to provide a Common pool information shared by all the gateway nodes in the pool.

As also discussed above with reference to FIG. 5b-5e it is preferred that the Common Pool Information in all gateway nodes GW1, GW2, GW3 of the pool 500 is updated when a status relating to the Common Pool Information has changed in a particular gateway node. The Common Pool Information may e.g. be updated each time a change occurs in a gateway node in the pool 500, or at predetermined time intervals, or at predetermined time intervals if a change has occurred after a previous update of the Common Pool Information. An update of the Common Pool Information may e.g. be done by the individual gateway node in which a change of status relating to the pool has occurred. The network gateway with a changed status may e.g. send its new status to the other gateway nodes in the pool 500. The effect of the update is that all the gateway nodes in the pool will share the same Common Pool Information.

Those skilled in the art having the benefit of this disclosure realize that there are may by many ways of obtaining the Common Pool Information and the precise manner of doing so is not critical for some embodiments of the present solution.

Example Operation 602:

A second exemplifying operation performed in the network gateway node GW2 is 30 blocking of at least one external PDN (e.g. PDN2) served by the gateway node GW2 for the creation of any new PDN-connections to the external PDN. As discussed above with reference to FIG. 5c, blocking a PDN identified by an APN (e.g. APN2) served by the network gateway node for creation of new PDN-connections may be done in any suitable manner.

Example Operation 603:

A third exemplifying operation performed in the gateway node GW2 is forwarding of any new creation of a PDN-connection (e.g. Pn) for a blocked external PDN identified by an APN served by the gateway node GW2 to a another gateway node GW3 in the gateway pool 500, based on the Common Pool Information indicating that the other gateway node GW3 is currently serving the blocked external PDN.

For example, with reference to FIGS. 5c and 7, assume that the second radio terminal RT2 requests creation of a new PDN-connection Pn to a blocked external PDN served by the gateway node GW2, e.g. the external PDN may be PDN2 identified by APN2 as described above with reference to FIGS. 5a-5d. Then the blocking gateway node GW2 can readily select another gateway node GW3, based on the Common Pool Information indicating that gateway node GW3 is currently serving the PDN blocked by GW2. The blocking gateway node GW2 will then forward the request for creation of the new PDN-connection Pn to GW3. The PDN-connection Pn will then be created in the new gateway node GW3. The new gateway node GW3 may send a create response message 603′ back to and received by the blocking gateway node GW2, which may forward the response to the radio terminal RT2. The radio terminal RT2 may then use the new gateway node GW3 for all communication during the lifetime of the new PDN-connection.

It should be added that forwarding of a creation of a PDN-connection for a blocked external PDN to another gateway node such as GW3 may alternatively be based on a predetermined forwarding scheme indicating a forwarding of the creation to GW3. If GW3 serves the PDN in question without blocking it, it is assumed that GW3 creates the requested PDN-connection. Conversely, if GW3 does not serve the PDN in question or is currently blocking the PDN, then GW3 may return the creation of the PDN-connection back to GW2, preferably with information indicating failure of creating the requested PDN connection, thus enabling GW2 to take appropriate actions, e.g. notifying the requesting entity about the failure of creating the requested PDN connection. Indeed, before the creation of the PDN-connection is returned to the blocking node GW2 it may have been forwarded by several other gateway nodes to several other gateway nodes in the gateway pool, e.g. in a sequential manner one after the other, where all of the other gateway nodes are blocking the external PDN or are not serving the external PDN in question. Such a forwarding scheme may be the same or similar as a so-called Round-Robin scheme.

The forwarding scheme may e.g. be configured centrally by the operator of the wireless communication network comprising the gateway nodes in question, e.g. using a network control function such as an Operation and Maintenance (OAM) function or similar. Alternatively, the forwarding scheme may e.g. be configured locally in the gateway nodes, e.g. by a service technician interacting locally with the gateway nodes in question, e.g. using suitable service equipment locally connected to the gateway node.

Example Operation 604:

A fourth exemplifying operation performed in the gateway node GW2 is moving at least one existing PDN connection, or a number or even all existing PDN connections (e.g. P2, P3) still connected to (i.e. associated with) an external PDN (e.g. PDN2) being blocked by the gateway node GW2 . The existing PDN-connection(s) is/are preferably moved to other gateway node(s) (e.g. GW3) in the gateway pool 500, preferably based on the pool information indicating that the other gateway node(s) is/are currently serving the blocked external PDN.

For example, with reference to FIGS. 5e and 7, assume that the second gateway node GW2 hosts a PDN-connection P2 for the first radio terminal RT1 to packet data network PDN2 and a PDN-connection P3 for the second radio terminal RT2 to packet data network PDN2, where PDN2 is identified by access point name APN2 served by GW2. Assume that the second gateway node GW2 now blocks PDN2, it will then still host the existing PDN-connections P2 and P3. Then, the existing PDN-connections can be moved from GW2 to the third gateway node GW3 in the pool 500, based on the Common Pool Information indicating that GW3 currently serves PDN2 now blocked by GW2.

It should be added that the existing PDN connections may alternatively be moved based on a predetermined moving scheme indicating a moving to another gateway node such as GW3. If GW3 serves the PDN in question without blocking it, it is assumed that GW3 creates a new PDN connection corresponding to the moved PDN-connection. Conversely, if GW3 does not serve the PDN in question or is currently blocking the PDN, then GW3 may forward the move of the PDN-connection back to the first gateway node GW2, preferably with information indicating failure of creating a corresponding PDN connection, thus enabling the first gateway to take appropriate actions. Indeed, before the move of the PDN-connection is returned to the blocking node GW2 it may have been moved by several other gateway nodes to several other gateway nodes in the gateway pool, e.g. in a sequential manner one after the other, where all of the other gateway nodes are blocking the PDN or are not serving the PDN. Such a forwarding scheme may be the same or similar as a so-called Round-Robin scheme.

The moving scheme may e.g. be configured centrally by the operator of the wireless communication network comprising the gateway node in question, e.g. using a network control function such as an Operation and Maintenance (OAM) function or similar. Alternatively, the moving scheme may e.g. be configured locally in the gateway nodes, e.g. by a service technician interacting locally with the gateway node in question, e.g. using suitable service equipment locally connected to the gateway node.

Before any existing PDN connection is moved it is preferred that the blocking and moving GW2 detects whether the first radio terminal RT1, associated with the existing PDN connection to be moved, is inactive or not, whereupon it is preferred that the existing PDN connection is only moved when the first radio terminal RT1 is inactive. Inactivity may e.g.

be concluded if GW2 is currently not communicating user-data with RT1 and/or if RT1 is in an idle state or in a power saving mode or similar.

Below, exemplifying operations presenting an embodiment for moving a PDN-connection will be discussed in more detail.

Example Operation 604a:

To move a PDN-connection (e.g. P3) it is preferred that a message is sent from the blocking gateway node GW2 to the radio terminal (e.g. RT2) for which the PDN-connection in question is hosted by the gateway node GW2, asking the radio terminal to disconnect the PDN-connection in question. For example, the blocking gateway node GW2 may send a “PDN connection deletion” preferably with “Reactivation Requested” in a message to the radio terminal for which the PDN-connection is hosted by the gateway node GW2.

Example Operation 604b:

As a response to the disconnect message received from the blocking gateway node GW2 it is preferred that the radio terminal (e.g. RT2) disconnects the PDN-connection (e.g. P3) and then tries to create the PDN-connection (e.g. P3) again by sending a PDN creation message that may be received by any gateway node in the pool, e.g. at the blocking gateway node GW2.

Example Operation 604c:

The receiving gateway node (e.g. GW2) finds, based on the pool information indicating that another gateway node (e.g. GW3) is currently serving the blocked external PDN, a destination gateway node for this PDN creation and forwards the PDN creation message to the destination gateway node (e.g. GW3). The PDN connection will be created here.

Example Operation 604d:

A create response may be sent back from the destination gateway node (e.g. GW3) and received by the blocking node GW2 and be forwarded back the radio terminal. The radio terminal will then use the destination gateway node for all communication during the lifetime of this PDN connection.

It should be added that as an alternative to operations 604a-604d based on sending a message (preferably a “PDN connection deletion” preferably with a “Reactivation Requested”) to the radio terminal in question it may be preferred to disconnect all existing PDN connections for the radio terminal Rt1 hosted by GW2. When the last PDN connection has been disconnected it is preferred that the mobility node (e.g. MME) serving RT2 sends a detach message comprising attach required to RT2.

FIG. 8 illustrates an exemplifying network gateway node configured to operatively perform the operations of the exemplifying embodiments described herein. As shown in FIG. 8, the network gateway node may comprise a processor arrangement 110 and a memory arrangement 120. The processor arrangement is preferably configured to operatively communicate with other network gateways and to operatively execute instructions stored in the memory arrangement. The memory arrangement comprises instructions executable by said processor arrangement such that the exemplifying network node is configured to perform the operations of the exemplifying embodiments described herein. The processor arrangement 110 may comprise any suitable digital and analogue circuitry that enables it to execute the instructions stored in the memory arrangement so as to perform the operations and functions of the exemplifying embodiments described herein. The digital and analogue circuitry of the processor arrangement 110 and the memory arrangement 120 may e.g. be the same or similar as those in known network gateways such as a GGSN or a PGW or similar, whereas the instructions are specific for the embodiment described herein.

Some embodiments described above may be summarized in the following manner:

One embodiment is directed to a method in a first network gateway node configured to act as a gateway of a core network to one or more external PDNs, and configured to provide connectivity for radio terminals (served by the first gateway node) to one or more of the PDNs, and configured to exchange information with one or more other network gateway nodes to provide a network gateway pool. The method comprises: obtaining pool information comprising information indicative of the external PDNs being served by each gateway node in the gateway pool to enable distribution of PDN connections among the gateway nodes in the gateway pool, and blocking at least one external PDN served by the first gateway node for creation of new PDN connections to the external PDN, and forwarding any creation of a new PDN connection for the blocked external PDN to a second gateway node in the gateway pool (500).

The method may further comprise: forwarding any creation of a new PDN connection for the blocked external PDN to the second gateway node based on a predetermined forwarding scheme indicating the second gateway node.

The forwarding (i.e. also the predetermined forwarding scheme) may be based on the pool information indicating that the second gateway node is currently serving the blocked external PDN.

The method may further comprise moving from the first gateway node to another gateway node in the gateway pool, at least one still existing PDN connection associated with the blocked external PDN.

The method may further comprise detecting that a radio terminal associated with the existing PDN connection is inactive and then moving the existing PDN connection to the other gateway node.

The method may further comprise moving the existing PDN connection to the other gateway node based on a predetermined moving scheme indicating the second gateway node.

The moving (i.e. also the predetermined moving scheme) may be based on the pool information indicating that the second gateway node is currently serving the blocked external PDN.

The moving may comprise sending to a radio terminal, associated with the still existing PDN connection to the blocked external PDN, a message instructing the radio terminal to disconnect the existing PDN connection.

The moving may comprise receiving from the radio terminal, a message requesting a PDN connection to the blocked external PDN, and forwarding the requesting message to another gateway node in the gateway pool. The forwarding may e.g. be based on a predetermined moving scheme and/or based on the pool information indicating that the other gateway node is currently serving the external PDN blocked by the first gateway.

The method may further comprise updating the pool information in all gateway nodes of the gateway pool when a status relating to the pool information has changed in the first gateway node.

The pool information may be updated at the time a change related to the pool information occurs in the first gateway node.

The pool information may be updated at a predetermined time interval, or at a predetermined time interval if a change related to the pool information has occurred since a previous update of the pool information.

The pool information may be updated in that the first gateway node sends a message to at least one of the other gateway nodes in the gateway pool, indicating a change of the status relating to the pool information in the first gateway.

The pool information may comprise information indicating that the external PDN is blocked by the first gateway for creation of new PDN connections to the external PDN.

The pool information comprises information indicating that a creation of a new PDN-connection to the external PDN is to be forwarded to the second gateway node currently serving the external PDN.

Some other embodiments described above may be summarized in the following manner:

One other embodiment is directed to a first network gateway node configured to act as a gateway of a core network to one or more external PDNs, and configured to provide connectivity for radio terminals (served by the first gateway node) to one or more of the PDNs, and configured to exchange information with one or more other network gateway nodes to provide a network gateway pool. The first network gateway node comprises a processor arrangement and a memory arrangement, where said memory arrangement comprising instructions executable by said processor arrangement, whereby the first network node is configured to: obtain pool information comprising information indicative of the external PDNs being served by each gateway node in the gateway pool to enable distribution of Packet Data Network, PDN, connections among the gateway nodes in the gateway pool, and block at least one external PDN served by the first gateway node for creation of new PDN connections to the external PDN, and forward any creation of a new PDN connection for the blocked external PDN to a second gateway node in the gateway pool.

The memory arrangement of the first network gateway may comprise instructions executable by the processor arrangement, whereby the first network node is configured to: forward any creation of a new PDN connection for the blocked external PDN to the second gateway node based on a predetermined forwarding scheme indicating the second gateway node.

The memory arrangement of the first network gateway may comprise instructions executable by the processor arrangement, whereby the first network node is configured to: forward any creation of a new PDN connection for the blocked external PDN to the second gateway node based on the pool information indicating that the second gateway (GW3) node is currently serving the blocked external PDN. The predetermined forwarding scheme and any other forwarding scheme suitable for the solution herein may be based on the pool information.

The memory arrangement may comprise instructions executable by the processor arrangement, whereby the first network node is configured to: move from the first gateway node to another gateway node in the gateway pool, at least one still existing PDN connection associated with the blocked external PDN.

The memory arrangement may comprise instructions executable by the processor arrangement, whereby the first network node is configured to: detect that a radio terminal associated with the existing PDN connection is inactive and then move the existing PDN connection to the other gateway node.

The memory arrangement may comprise instructions executable by the processor arrangement, whereby the first network node is configured to: move the existing PDN connection to the other gateway node based on a predetermined moving scheme indicating the second gateway node.

The memory arrangement may comprise instructions executable by the processor arrangement, whereby the first network node is configured to: move the existing PDN connection to the other gateway node based on a predetermined moving scheme based on the pool information indicating that the second gateway node is currently serving the blocked external PDN. The predetermined moving scheme and any other moving scheme suitable for the solution herein may be based on the pool information.

The memory arrangement may comprise instructions executable by the processor arrangement, whereby the first network node is configured to: move the existing PDN connection to the other gateway node by sending to a radio terminal, associated with the still existing PDN connection to the blocked external PDN, a message instructing the radio terminal to disconnect the existing PDN connection.

The memory arrangement may comprise instructions executable by the processor arrangement, whereby the first network node is configured to: move the existing PDN connection to the other gateway node by receive from the radio terminal, a message requesting a PDN connection to the blocked external PDN, and forward the requesting message to another gateway node in the gateway pool, based on the pool information indicating that the other gateway node is currently serving the external PDN blocked by the first gateway. The forwarding may e.g. be based on a predetermined moving scheme and/or based on the pool information indicating that the other gateway node is currently serving the external PDN blocked by the first gateway.

The memory arrangement may comprise instructions executable by the processor arrangement, whereby the first network node is configured to: update the pool information in all gateway nodes of the gateway pool when a status relating to the pool information has changed in the first gateway node.

The memory arrangement may comprise instructions executable by the processor arrangement, whereby the first network node is configured to: update the pool information is at the time a change related to the pool information occurs in the first gateway node.

The memory arrangement may comprise instructions executable by the processor arrangement, whereby the first network node is configured to: update the pool information at a predetermined time interval, or at a predetermined time interval if a change related to the pool information has occurred since a previous update of the pool information.

The memory arrangement may comprise instructions executable by the processor arrangement, whereby the first network node is configured to: update the pool information in that the first gateway node sends a message to at least one of the other gateway nodes in the gateway pool, indicating a change of the status relating to the pool information in the first gateway.

The pool information may comprise information indicating that the external PDN is blocked by the first gateway for creation of new PDN connections to the external PDN.

The pool information may comprise information indicating that a creation of a new PDN connection to the external PDN is to be forwarded to the second gateway node currently serving the external PDN.

The foregoing description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that any of the example embodiments presented herein may be used in conjunction, or in any combination, with one another.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the example embodiments, that the example embodiments may be implemented at least in part by means of both hardware and software, and that several “means”, “units” or “devices” may be represented by the same item of hardware.

### ABBREVIATIONS

S1-MME: Reference point for the control plane protocol between E-UTRAN and MME.
S1-U: Reference point between E-UTRAN and Serving GW for the per bearer user plane tunnelling and inter eNodeB path switching during handover.
S3: It enables user and bearer information exchange for inter 3GPP access network mobility in idle and/or active state.
S4: It provides related control and mobility support between GPRS Core and the 3GPP Anchor function of Serving GW. In addition, if Direct Tunnel is not established, it provides the user plane tunnelling.
S5: It provides user plane tunnelling and tunnel management between Serving GW and PDN GW. It is used for Serving GW relocation due to UE mobility and if the Serving GW needs to connect to a non-collocated PDN GW for the required PDN connectivity.
S6a: It enables transfer of subscription and authentication data for authenticating/authorizing user access to the evolved system (AAA interface) between MME and HSS.
Gx: It provides transfer of (QoS) policy and charging rules from PCRF to Policy and Charging Enforcement Function (PCEF) in the PDN GW.
S8: Inter-PLMN reference point providing user and control plane between the Serving GW in the VPLMN and the PDN GW in the HPLMN. S8 is the inter PLMN variant of S5.
S9: It provides transfer of (QoS) policy and charging control information between the Home PCRF and the Visited PCRF in order to support local breakout function.
S10: Reference point between MMEs for MME relocation and MME to MME information transfer.
S11: Reference point between MME and Serving GW.
S12: Reference point between UTRAN and Serving GW for user plane tunnelling when Direct Tunnel is established. It is based on the Iu-u/Gn-u reference point using the GTP-U protocol as defined between SGSN and UTRAN or respectively between SGSN and GGSN. Usage of S12 is an operator configuration option.
S13: It enables UE identity check procedure between MME and EIR.
SGi: It is the reference point between the PDN GW and the packet data network. Packet data network may be an operator external public or private packet data network or an intra operator packet data network, e.g. for provision of IMS services. This reference point corresponds to Gi for 3GPP accesses.
Rx: The Rx reference point resides between the AF and the PCRF in the TS 23.203 [6].
AN Access Network
ARP Allocation and Retention Priority
BSC Base Station Controller
BSS Base Station System
BTS Base Station
CN Core Network
eNodeB enhanced Node B
EPC Evolved Packet Core
EPS Evolved Packet System
E-UTRAN Evolved Universal Terrestrial Radio Access Network
GERAN GSM Edge Radio Access Network
GGSN Gateway GPRS Support Node
GPRS General Packet Radio Service
GSM Global Communications System
GW Gateway
IMSI International Mobile Station Identity
IP Internet Protocol
LTE Long Term Evolution
MME Mobility Management Entity
MSC Mobile Switching Center
PCEF Policy and Charging Enforcement Function
PCRF Policy and Charging Rules Function
PDN Packet data Network
PGW PDN Gateway
PLMN Public Land Mobile Network
RAN Radio Access Network
RNC Radio Network Controller
SGSN Serving GPRS Support Node
SGW Serving Gateway
UE User Equipment
UMTS Universal Mobile Telecommunications System
UTRAN UMTS Terrestrial Radio Access Network
VLR Visitor Location Register
VS Vendor Specific

1. A method in a first network gateway node configured to act as a gateway of a core network to one or more external Packet Data Networks, PDNs, and configured to provide connectivity for radio terminals to one or more of the PDNs, and configured to exchange information with one or more other network gateway nodes to provide a network gateway pool, the method comprising:
obtaining pool information comprising information indicative of the external PDNs being served by each gateway node in the gateway pool to enable distribution of Packet Data Network, PDN, connections among the gateway nodes in the gateway pool,
blocking at least one external PDN served by the first gateway node for creation of new PDN connections to the external PDN,
forwarding any creation of a new PDN connection for the blocked external PDN to a second gateway node in the gateway pool.

2. The method according to claim 1, further comprising: forwarding any creation of a new PDN connection for the blocked external PDN to the second gateway node based on a predetermined forwarding scheme indicating the second gateway node.

3. The method according to claim 1, wherein: the forwarding is based on the pool information indicating that the second gateway node is currently serving the blocked external PDN.

4. The method according to claim 1, further comprising: moving from the first gateway node to another gateway node in the gateway pool, at least one still existing PDN connection associated with the blocked external PDN.

5. The method according to claim 4, further comprising: detecting that a radio terminal associated with the existing PDN connection is inactive and then moving the existing PDN connection to the other gateway node.

6. The method according to claim 4, further comprising: moving the existing PDN connection to the other gateway node based on a predetermined moving scheme indicating the second gateway node.

7. The method according to claim 4, wherein: the moving is based on the pool information indicating that the second gateway node is currently serving the blocked external PDN.

8. The method according to claim 4, wherein: the moving comprises
sending to a radio terminal, associated with the still existing PDN connection to the blocked external PDN, a message instructing the radio terminal to disconnect the existing PDN connection.

9. The method according to claim 4, wherein the moving comprises:
receiving from the radio terminal, a message requesting a PDN connection to the blocked external PDN, and
forwarding the requesting message to another gateway node in the gateway pool.

10. The method according to claim 1, further comprising: updating the pool information in all gateway nodes of the gateway pool when a status relating to the pool information has changed in the first gateway node.

11. The method according to claim 10, wherein: the pool information is updated at the time a change related to the pool information occurs in the first gateway node.

12. The method according to claim 10, wherein: the pool information is updated at a predetermined time interval, or at a predetermined time interval if a change related to the pool information has occurred since a previous update of the pool information.

13. The method according to claim 10, wherein: the pool information is updated in that the first gateway node sends a message to at least one of the other gateway nodes in the gateway pool, indicating a change of the status relating to the pool information in the first gateway.

14. The method according to claim 1, wherein: the pool information comprises information indicating that the external PDN is blocked by the first gateway for creation of new PDN connections to the external PDN.

15. The method according to claim 1, wherein: the pool information comprises information indicating that a creation of a new PDN-connection to the external PDN is to be forwarded to the second gateway node currently serving the external PDN.

16. A first network gateway node configured to act as a gateway of a core network to one or more external Packet Data Networks, PDNs, and configured to provide connectivity for radio terminals to one or more of the PDNs, and configured to exchange information with one or more other network gateway nodes to provide a network gateway pool, where the first network gateway node comprises a processor arrangement and a memory arrangement, said memory arrangement comprising instructions executable by said processor arrangement, whereby the first network node is configured to:
obtain pool information comprising information indicative of the external PDNs being served by each gateway node in the gateway pool to enable distribution of Packet Data Network, PDN, connections among the gateway nodes in the gateway pool,
block at least one external PDN served by the first gateway node for creation of new PDN connections to the external PDN,
forward any creation of a new PDN connection for the blocked external PDN to a second gateway node in the gateway pool.

17. The first network gateway according to claim 16, wherein the memory arrangement comprises instructions executable by the processor arrangement, whereby the first network node is configured to: forward any creation of a new PDN connection for the blocked external PDN to the second gateway node based on a predetermined forwarding scheme indicating the second gateway node.

18. The first network gateway according to claim 16, wherein the memory arrangement comprises instructions executable by the processor arrangement, whereby the first network node is configured to: forward any creation of a new PDN connection for the blocked external PDN to the second gateway node based on the pool information indicating that the second gateway node is currently serving the blocked external PDN.

19. The first network gateway according to claim 16, wherein the memory arrangement comprises instructions executable by the processor arrangement, whereby the first network node is configured to: move from the first gateway node to another gateway node in the gateway pool, at least one still existing PDN connection associated with the blocked external PDN.

20. The first network gateway according to claim 19, wherein the memory arrangement comprises instructions executable by the processor arrangement, whereby the first network node is configured to: detect that a radio terminal associated with the existing PDN connection is inactive and then move the existing PDN connection to the other gateway node.

21. The first network gateway according to claim 19, wherein the memory arrangement comprises instructions executable by the processor arrangement, whereby the first network node is configured to: move the existing PDN connection to the other gateway node based on a predetermined moving scheme indicating the second gateway node.

22. The first network gateway according to claim 19, wherein the memory arrangement comprises instructions executable by the processor arrangement, whereby the first network node is configured to: move the existing PDN connection to the other gateway node based on the pool information indicating that the second gateway node is currently serving the blocked external PDN.

23. The first network gateway according to claim 19, wherein the memory arrangement comprises instructions executable by the processor arrangement, whereby the first network node is configured to: move the existing PDN connection to the other gateway node by sending to a radio terminal, associated with the still existing PDN connection to the blocked external PDN, a message instructing the radio terminal to disconnect the existing PDN connection.

24. The first network gateway according to claim 19, wherein the memory arrangement comprises instructions executable by the processor arrangement, whereby the first network node is configured to: move the existing PDN connection to the other gateway node by
receive from the radio terminal, a message requesting a PDN connection to the blocked external PDN, and
forward the requesting message to another gateway node in the gateway pool.

25. The first network gateway according to claim 16, wherein the memory arrangement comprises instructions executable by the processor arrangement, whereby the first network node is configured to: update the pool information in all gateway nodes of the gateway pool when a status relating to the pool information has changed in the first gateway node.

26. The first network gateway according to claim 25, wherein the memory arrangement comprises instructions executable by the processor arrangement, whereby the first network node is configured to: update the pool information at the time a change related to the pool information occurs in the first gateway node.

27. The first network gateway according to claim 25, wherein the memory arrangement comprises instructions executable by the processor arrangement, whereby the first network node is configured to: update the pool information at a predetermined time interval, or at a predetermined time interval if a change related to the pool information has occurred since a previous update of the pool information.

28. The first network gateway according to claim 25, wherein the memory arrangement comprises instructions executable by the processor arrangement, whereby the first network node is configured to: update the pool information in that the first gateway node sends a message to at least one of the other gateway nodes in the gateway pool, indicating a change of the status relating to the pool information in the first gateway.

29. The first network gateway according to claim 16, wherein: the pool information comprises information indicating that the external PDN is blocked by the first gateway for creation of new PDN connections to the external PDN.

30. The first network gateway according to claim 16, wherein: the pool information comprises information indicating that a creation of a new PDN-connection to the external PDN is to be forwarded to the second gateway node currently serving the external PDN.
